(19) United States
(12) Patent Application Publication
(10) Pub. No.: US 2022/0229766 A1
(43) Pub. Date: Jul. 21, 2022

(54) DEVELOPMENT OF APPLICATIONS USING TELEMETRY DATA AND PERFORMANCE TESTING

(71) Applicant: VMWARE, INC., Palo Alto, CA (US)

(72) Inventors: Palash Jain, Bangalore (IN); Vishweshwar Palleboina, Bangalore (IN); Venkata Ramana Parimi, Bangalore (IN); Susobhit Panigrahi, Bangalore (IN); Aishwary Lnu, Bangalore (IN)

(21) Appl. No.: 17/224,255

(22) Filed: Apr. 7, 2021

(30) Foreign Application Priority Data
Jan. 21, 2021 (IN) 202141002951

(51) Int. Cl. G06F 11/36

(52) U.S. Cl. CPC G06F 11/3684; G06F 11/3692; G06F 11/3688

(57) ABSTRACT

Described herein are systems, methods, and software to develop applications using telemetry data and performance testing. In one implementation, a development computing system may obtain telemetry data associated with the application and use the telemetry data to determine iteration counts for testing each feature of the application. A performance test may then be executed by the development computing system on the application using the iteration counts to determine computing resource usage associated with the application. From the computing resource usage, the development computing system may identify replacement lines of code for the application to improve the computing resource usage.

### RELATED APPLICATIONS

Benefit is claimed under 35 U.S.C. 119(a)-(d) to Foreign Application Serial No. 202141002951 filed in India entitled “DEVELOPMENT OF APPLICATIONS USING TELEMETRY DATA AND PERFORMANCE TESTING”, on Jan. 21, 2021, by VMware, Inc., which is herein incorporated in its entirety by reference for all purposes.

### TECHNICAL BACKGROUND

In computing environments, applications are deployed to provide various operations in the computing environment. These applications may be executed across one or more containers, virtual machines, or standalone applications on physical host computing systems. Prior to deploying an application, a developer may generate the code for the application, compile the application, and test the application using hardware available to the developer. From the test, the user may identify errors in the code and correct the errors prior to deploying the application in the computing environment.

However, while the developer may generate the code for the application, difficulties can arise in determining how to test the code to accurately reflect the deployment environment for the application. Additionally, even if errors are not identified in the code, inefficiencies in one or more lines of the code may use unnecessary resources to provide a required operation. These resources may include processing resources, memory resources, or other physical resources associated with the one or more hosts for the application.

### SUMMARY

The technology described herein assists in developing applications using telemetry data and performance testing. In one implementation, an application testing service may obtain telemetry data associated with an application with a plurality of features and determine a usage rate associated with each of the plurality of features based on the telemetry data. The testing service may further identify configuration metadata associated with the application that indicates at least a scale factor for scaling the usage rates of the plurality of features and determining one or more iteration counts for testing the application based on the configuration metadata and the usage rates. Once the iteration counts are determined, the testing service may generate a context object that indicates at least the one or more iteration counts for testing the application.

In some implementations, the testing service initiates a test of the application using the context object to determine computing resource usage associated with a plurality of functions in the plurality of features. The testing service further identifies a subset of the functions with a highest computing resource usage and identifies one or more lines of code in the subset of features associated with the highest computing resource usage. After identifying the one or more lines of code, the testing service determines replacement code for the one or more lines of code to improve computing resource usage and generates a summary that indicates the one or more lines of code and the replacement code.

### BRIEF DESCRIPTION OF THE DRAWINGS

FIG. 1 illustrates a computing environment to use telemetry data and performance testing to develop an application according to an implementation.

FIG. 2 illustrates an operation to determine iterations for testing an application according to an implementation.

FIG. 3 illustrates an operation to test an application according to an implementation.

FIG. 4 illustrates an operational scenario of generating a context object for application testing according to an implementation.

FIG. 5 illustrates an operational scenario of generating a summary of application testing according to an implementation.

FIG. 6 illustrates a testing computing system to test an application according to an implementation.

### DETAILED DESCRIPTION

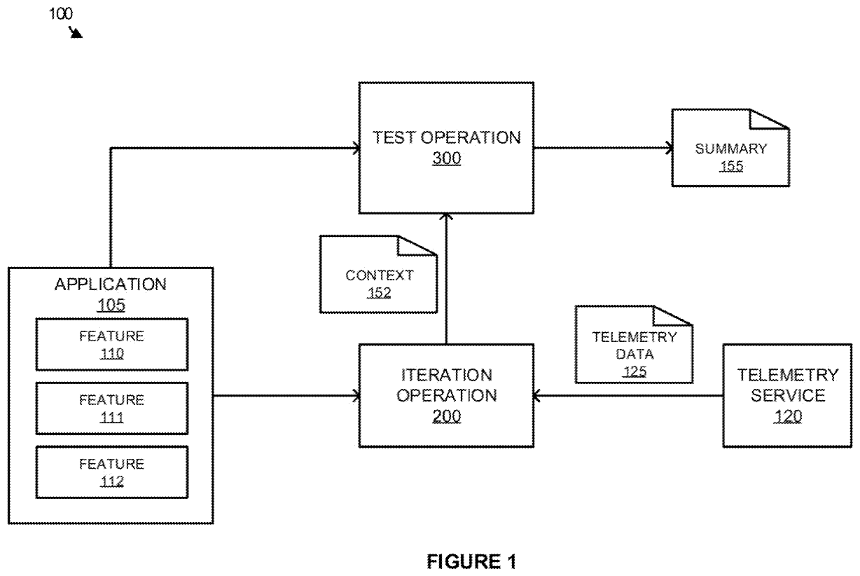

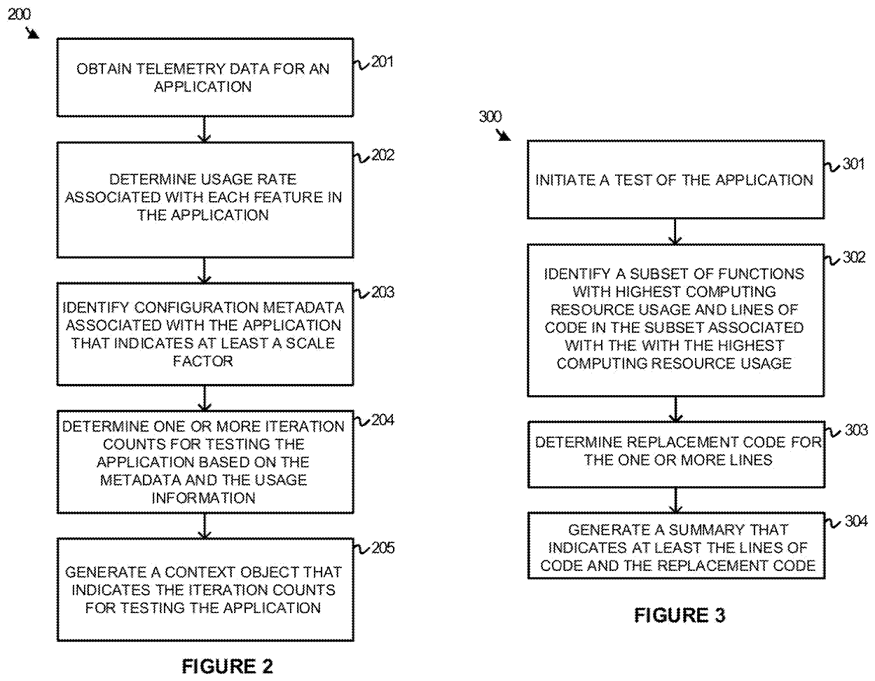

FIG. 1 illustrates a computing environment 100 to use telemetry data and performance testing to develop an application according to an implementation. Computing environment 100 includes application 105, context 152, telemetry service 120, telemetry data 125, and summary 155. Application 105 further includes features 110-112 representative of different features available for application 105. Computing environment 100 further includes iteration operation 200 that is described in further detail in FIG. 2 and test operation 300 that is described in further detail in FIG. 3. Operations 200 and 300 may be performed by a local user computing system, such as a desktop or laptop computing system, may be performed on a server, or may be performed in some combination thereof. Application 105 may be written Go programming language, C programming language, Python programming language, or some other programming language.

In operation, a developer may generate, or update, code associated with application 105, wherein application 105 includes features 110-112. Features 110-112 may each correspond to one or more functions or function blocks. Each feature of features 110-112 may comprise a login feature, a database processing feature, or some other feature that provides a different operation or service in the application. Once the code is generated for application 105, the application may be tested by the developer prior to deploying the application in an active computing environment. Here, to test the application, iteration operation 200 is performed, wherein iteration operation 200 may process application 105 and telemetry data 125 from telemetry service 120 to determine the number of iterations that each of the features should be executed for testing.

In some implementations, telemetry service 120 may extract samples of the different features that are executed in an active computing environment. Iteration operation 200 may identify the different features that exist in application 105 and determine the usage rate associated with each of the different features using identifiers (such as tags) from telemetry service 120. For example, telemetry service 120 may indicate that feature 110 is executed five times more than features 111-112. Once the usage rates are identified for the various features, context 152 may be generated based on scaling factor associated with the usage rates. In some implementations, as telemetry service 120 maintains samples for the execution of the different features, the usage rates may be scaled to the number of times that each of the features is executed in the deployment environment. Once the iterations are determined for each feature of features 110-112, the iteration information may be added to context 152 for processing by test operation 300.

After generating context 152, test operation 300 may process context 152 and application 105 to generate summary 155. In some implementations, the iterations associated with each of the features may be used to specify the number of times each of the features are executed in the deployment environment. In some examples, context 152 may further indicate configuration information for the deployment environment of the application. The configuration information may comprise hardware information for one or more computers to host the application, a type of container or virtual machine for the application, and a run length associated with the application. Based on the configuration information and the iteration counts for the features, test operation 300 may initiate a test on the application determine which functions in features 110-112 are using the most computing resources and determine lines of code in the functions can be replaced with different code to reduce the amount of resources being used. For example, in the original code of feature 110, the developer may use a first variable type, while a second variable type may reduce the resource usage associated with feature 110. As a result, summary 155 may indicate the feature or function associated with the increased resource usage, identify the one or more lines of code associated with the increased usage, and indicate a suggestion to change the first variable type to a second variable type. In some examples, the developer may be presented with an option to accept the suggested changes and may further be provided with an example of how to replace the required code. The testing may further provide information about the amount of resources that could be saved using the different code, such as processing resources or memory resources saved using the changed code.

FIG. 2 illustrates an operation 200 to determine iterations for testing an application according to an implementation. The steps of operation 200 are referenced parenthetically in the paragraphs that follow with reference to computing environment 100 of FIG. 1. The steps of operation 200 may be performed locally at a developer computing system or may be performed at least partially remotely on a server or other computing system.

As depicted, operation 200 includes obtaining (201) telemetry data associated with an application with a plurality of features and determining (202) a usage rate associated with each of the plurality of features based on the telemetry data. In some implementations, after an application is deployed in computing environment 100, telemetry service 120 may monitor the use of different features of the application. In monitoring the use of the different features, telemetry service 120 may sample the different features that are being executed as part of the application. Once sampled, telemetry service 120 may provide telemetry data 125 to iteration operation 200 indicating statistical usage information associated with the different features. Based on the statistical usage information provided by telemetry service 120, operation 200 may determine the usage rate of each feature based on the sampling of a feature as a function of the overall usage. For example, telemetry service 120 may indicate that functions associated with feature 110 are used five times more frequently than feature 112. This can be indicated based on tags or other identifiers that can indicate the feature

Once the usage rate is identified for each of the features, operation 200 further identifies (203) configuration metadata associated with the application, wherein the configuration metadata indicates at least a scale factor for scaling the usage rates of the plurality of features. Once identified, operation 200 determines (204) one or more iteration counts for testing the application based on the configuration metadata and the usage rate. Because the usage of each of the functions is sampled by telemetry service 120, iteration operation 200 may scale or multiply the usage rate by the scale factor to accurately reflect the usage of the application during a time period. In some examples, the scale factor may be defined by an administrator or the scale factor may be defined by the telemetry service based on the sample rate associated with sample the execution of the different features. After the one or more iteration counts are identified, operation 200 may generate (205) a context object, wherein the context object indicates at least the one or more iteration counts for testing the application. In some examples, in addition to the iteration counts, the context object (file, data structure, and the like) may include configuration information associated with the computing environment. The configuration information may include hardware information for one or more computers to host the application, a type of container or virtual machine for the application, a run length associated with the application, or some other information associated with the application. The configuration information may be used when testing the application to define resource usage associated with the application.

In some implementations, rather than calculating the iteration counts for testing an application, the developer may assign an iteration count to a feature. This assignment of the iteration count may be used when the application has not been deployed, when one or more new features are added to an application, or for some other purpose. In some examples, the developer may also omit the testing associated with a feature or limit the testing of a feature to preserve resources.

FIG. 3 illustrates an operation 300 to test an application according to an implementation. The steps of operation 300 are referenced parenthetically in the paragraphs that follow with reference to systems and elements in FIG. 1. The steps of operation 300 may be performed by a developer computing system, such as a laptop or desktop workstation, or may be performed at least in part using a remote server or secondary computing system.

As depicted, operation 300 includes initiating (301) a test of an application using a context object to determine computing resource usage associated with a plurality of functions in the plurality of features. As described herein an application may include multiple features that each include one or more functions. For example, a login feature may include a first set of functions that are used to retrieve user credentials, such as a username and password, while a second set of functions may be used to generate and provide a token to the requesting user. In some implementations, the different features of an application may be executed at a different rate. For example, a first feature may be executed at a greater rate than another feature. To provide improved testing on the application, the context object may indicate iterations that each of the features is executed to determine resource usage for the functions that are part of the features, wherein the resource usage may comprise processing system usage, memory usage, or some other physical resource usage by the application.

In some examples, the context object may further provide configuration information about the deployment environment, wherein the configuration information may indicate information about the host or hosts for the application, the amount of resources available to the application, the length of execution of the application, or some other configuration information for the deployment of the application. Based on the configuration information, the testing may occur locally on the developer computing device or may occur on a second computing device or server capable of providing the deployment environment. As each iteration of the features is executed based on the configuration information, the computing resources may be determined for the functions in the features.

Once the computing resource usage is identified for the functions, operation 300 further identifies (302) a subset of the functions with a highest computing resource usage and identifies one or more lines of code in the subset of features associated with the highest computing resource usage. In some examples, operation 300 may identify a set number of functions with the highest usage and identify one or more lines of code in each of the functions associated with the highest resource usage. Once the lines of code are identified, operation 300 determines (303) replacement code for the one or more lines and generates (304) a summary that indicates at least the lines of code and the replacement code.

In some implementations, the one or more lines of code identified in the functions may correspond to lines of code in a dictionary that can be replaced with alternative code that provides the same function. For example, lines of code may be identified that use variables that use more memory resources than alternative variables that can provide the same function. Additionally, different forms of a loop function may be identified that can reduce processing resource usage or memory resource usage.

In some implementations, one type of computing resource usage may be favored over another based on the configuration information. For example, processing system resource usage may be favored over memory resource usage based on an application having a short runtime or the type of virtualization environment used for the application. In contrast, memory resource usage may be favored over processing system resources based on a longer runtime for the application or the type of virtualization environment for the application. In other examples, a combination of the two may be used to select the functions with the highest resource usage. Once the highest resource usage functions are identified, one or more lines of code with available alternatives are identified in the functions for the summary.

In some examples, the summary may indicate the functions in the application that are associated with the highest computing resources. The summary may indicate the functions with the highest processing system resources, the highest memory resource usage, or some other physical resource usage, including combinations thereof. The summary may indicate code line numbers or print the lines of code with highlights or emphasized changes to the lines selected from the functions with the highest resource usage. For example, in a line of code, a variable or function may be highlighted with potential replacement code to improve the computing resource usage associated with the function.

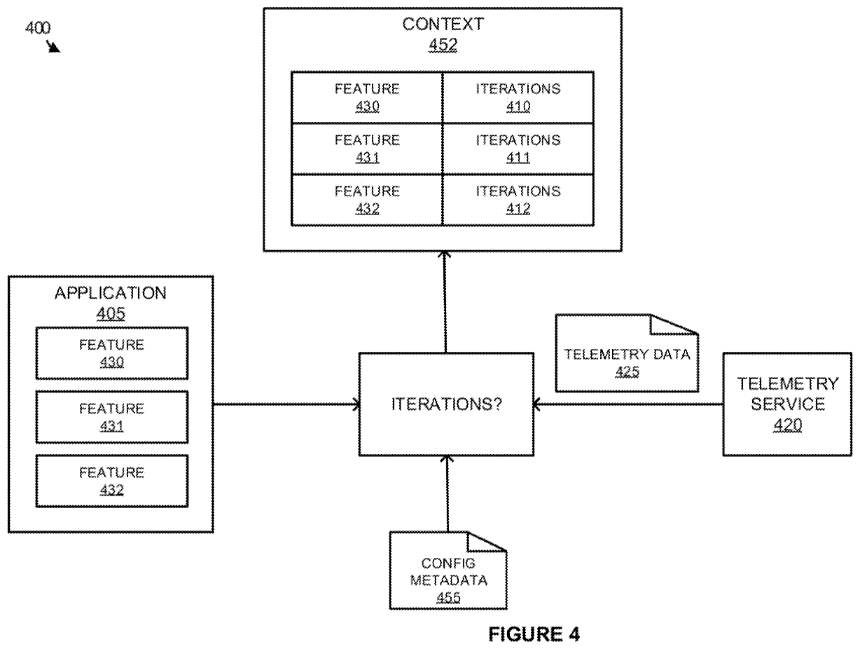

FIG. 4 illustrates an operational scenario 400 of generating a context object for application testing according to an implementation. Operational scenario 400 includes application 405, configuration metadata 455, telemetry service 420, telemetry data 425, and context 452. Application 405 includes features 430-432, and context 452 associates features 430-432 with corresponding iterations 410-412. Operational scenario 400 may be performed by a developer computing system, such as a desktop computing system or laptop, or may be performed by one or more server computing systems.

In operation, application 405 is processed by a computing system to determine context 452. To determine the context, the computing system may obtain telemetry data 425 from telemetry service 420, wherein the telemetry data indicates usage information associated with the different features 430-432 of application 405. In some examples, telemetry service 420 may sample the different functions executed by the code to identify usage information associated with application 405. Based on function identifiers in telemetry data 425, the computing system may determine the rate at which each feature is executed. In addition to the usage rates for each of the functions, the computing system may further obtain configuration metadata, wherein the metadata indicates at least a scale factor for scaling the usage rates determined from the usage data. In some implementations, the usage rate for each of the features may be multiplied by the scale factor to determine the number of iterations associated with each of the features. In particular, because telemetry service 420 may not monitor every use of the different features, the scale factor may be used to ensure the context for testing the application accurately reflects the usage of the application in the deployment environment.

Once iterations 410-412 are determined for each feature of features 430-432, context 452 is generated that associates the various iterations with the features. Context 452 may further include configuration information associated with the deployment computing environment, wherein the configuration information may include hardware information for one or more computers to host the application, a type of container or virtual machine for the application, and a run length associated with the application. The information may be used to reflect the deployment environment when testing the application. In some examples, the hardware configuration and virtualization configuration (container, virtual machine, and the like) may determine where the application is tested. For example, a first application may be capable of being executed locally, while a second application may be required to be executed on one or more host computing systems to provide the appropriate configuration.

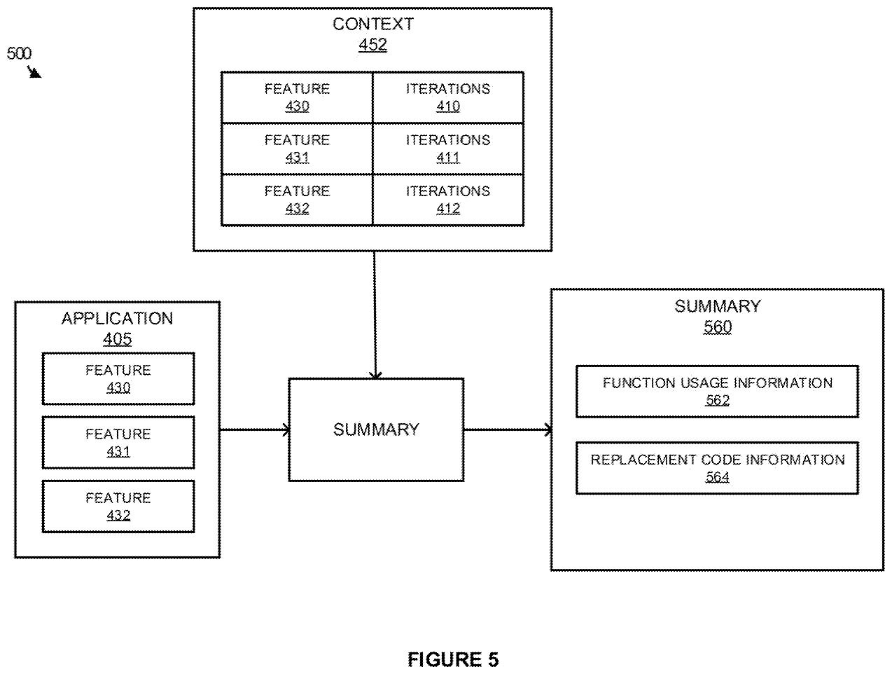

FIG. 5 illustrates an operational scenario 500 of generating a summary of application testing according to an implementation. Operational scenario 500 includes application 405 and context 452 from FIG. 4 and further includes summary 560 with function usage information 562 and replacement code information 564.

In operation, context 452 is representative of a data object, such as a file or data structure, that provides information about the testing environment for application 405. When an application is to be tested, each feature 430-432 in the application is associated with an iteration that is used to approximate the number of times that each of the features is executed when the application is deployed. The iterations may represent the full life-cycle of the application or may represent a portion of the life-span of the application. In testing the application, the testing computing system may monitor the resource usage associated with each feature of features 430-432. The computing resource usage may include processing system usage, memory usage, or some other computing resource usage.

As the computing resource usage is monitored for testing the application, the testing computing system may determine which of the functions in the application are associated with the highest resource usage. Once determined, the computing system may identify lines of code in the functions with possible replacement code that can be used to reduce the amount of resource usage by the application. For example, the testing system may consult a dictionary that associates code with replacement code that can provide more efficient resource usage. The replacement code may include different loop structure, variables, or some other replacement code to improve the resource usage associated with the highest resource usage functions. The dictionary may be updated by one or more administrators or users, may be provided with the programming language, or may be provided in some other manner to relate current code to replacement code.

As an illustrative example, operational scenario 500 may determine that feature 430 is associated with the most processing resource usage for application 405. In response to the determination, the computing system may inspect the code to identify portions of code with possible replacement code. If a replacement exists, the portion of code may be tagged to be presented to the developer along with the replacement code suggestions.

Here, based on context 452 and the testing of application 405, generate summary 560 that includes function usage information 562 and replacement code information 564. Function usage information 562 may provide a list, a table, or some other data structure that indicates the functions associated with the highest resource usage, wherein the summary may indicate expected processing system resource usage, memory system resource, usage or some other resource usage associated with the function. Function usage information 562 may further provide information about the features with the highest resource usage. In some examples, function usage information 562 may include resource usage of a defined number of functions with the highest resource usage, such as the ten functions with the highest processing resource usage. Replacement code information 564 may indicate the one or more lines of code identified in the functions that can be replaced with more efficient code. In some examples, replacement code information 564 may indicate line numbers associated with the identified code, samples from the identified code, or some other information to identify the code to be replaced. In some examples, replacement code information 564 may provide additional information about the resource usage improvements using the replacement code. The additional information may indicate the processing resources preserved, the memory resources preserved, or some other information about resource usage improvements by making the code changes.

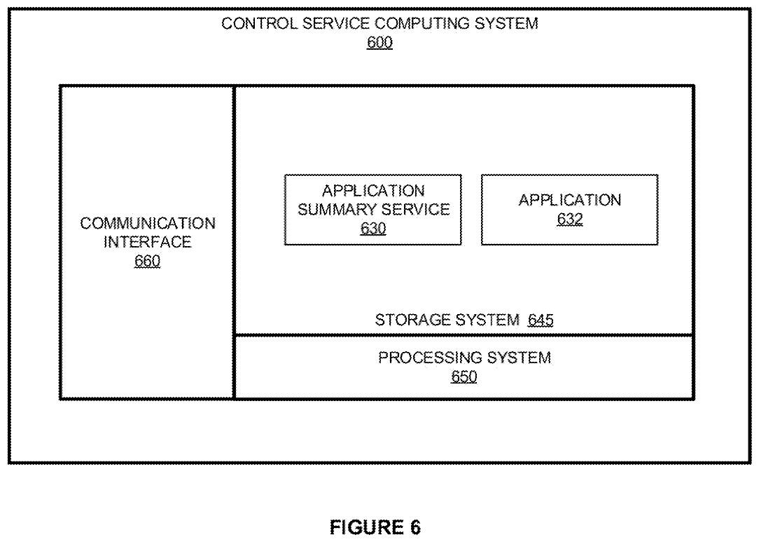

FIG. 6 illustrates a testing computing system 600 to test an application according to an implementation. Computing system 600 is representative of any computing system or systems with which the various operational architectures, processes, scenarios, and sequences disclosed herein for an application testing computing system can be implemented. Computing system 600 is an example computing system for implementing computing environment 100 of FIG. 1, although other examples may exist. Computing system 600 includes storage system 645, processing system 650, and communication interface 660. Processing system 650 is operatively linked to communication interface 660 and storage system 645. Communication interface 660 may be communicatively linked to storage system 645 in some implementations. Computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format—including combinations thereof.

Processing system 650 comprises microprocessor and other circuitry that retrieves and executes operating software from storage system 645. Storage system 645 may include volatile and nonvolatile, removable and non-removable media implemented in any method or technology for storage of information, such as computer readable instructions, data structures, program modules, or other data. Storage system 645 may be implemented as a single storage device, but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises application summary service 630 (hereinafter “service 630”) capable of providing at least operation 200 of FIG. 2 and operation 300 of FIG. 3, and further includes application 632. The operating software on storage system 645 may further include an operating system, utilities, drivers, network interfaces, applications, or some other type of software. When read and executed by processing system 650 the operating software on storage system 645 directs computing system 600 to operate as described herein.

In at least one implementation, service 630 obtains telemetry data associated with application 632, wherein application 632 includes a plurality of features. These features may each provide a different operation for the application and include a set of functions to perform the feature. Features may include a login feature, a database feature, or some other feature of an application. The telemetry data may indicate a sample of the functions of the features that were executed in accordance with a previous version of the application, permitting application summary service 630 to determine a usage rate associated with each of the features. Based on the usage rate associated with each of the features, summary service 630 may direct processing system 650 to identify configuration metadata associated with the application, wherein the configuration metadata indicates at least a scale factor for scaling the usage rates of the plurality of features. The scale factor may be defined by an administrator or may be provided in association with the telemetry data indicating a scaling associated with the samples for the telemetry data. The scale factor may represent the overall life-cycle of the application or may represent a portion of the life-cycle of the application. The scale factor may be multiplied by the usage rate for each feature to determine the iteration numbers associated with each feature for the test of the application. Once the iteration numbers are identified for each of the features, a context may be generated that indicates at least the iteration counts for each of the features.

In some implementations, the context may further include configuration information associated with the deployment environment for the application. The configuration information may include hardware information for one or more computers to host the application, a type of container or virtual machine for the application, or a run length associated with the application. The information may be used to define a testing environment for the application and dictate what resources are prioritized over other resources for the testing of the application. For example, applications with a short life-cycle may prioritize processing system resources over memory resources, while applications with a longer life-cycle may prioritize memory resources over processing system resources. Additionally, based on the type of deployment environment, such as a container environment over a virtual machine environment, different resources may be consumed by the application. The deployment environment may further dictate whether the application can be tested on the computing system local to the developer or executed on a separate computing system with hardware or operating resources equivalent to the deployment environment.

In some examples, rather than using the telemetry information to determine the iterations associated with each of the features, the developer may dictate the iteration counts associated with one or more of the features and include the iterations in the context. Advantageously, the administrator may add iteration counts for new features, remove iterations for features that are not relevant to the testing, or make some other definition of the iterations.

After the context object is generated, application summary service 630 directs processing system 650 to initiate a test of the application using the context object to determine computing resource usage associated with a plurality of functions in the plurality of features. This testing may occur locally on the developer computing system or may be executed on a remote computing system capable of providing the required environment for the application. In some examples, a monitoring service may monitor the execution of the application and log the computing resource usage associated with each of the functions. Once the computing resource usage is determined, application summary service 630 directs processing system 650 to identify a subset of functions from the plurality of functions with a highest resource usage from the test and identify one or more lines of code in the subset of functions associated with the highest computing resource usage. In some implementations, application summary service 630 may generate a hierarchy based on the resource usage associated with the functions, wherein the hierarchy may be based on the memory resource usage, processing system resource usage, or some combination thereof. Once in a hierarchy, the functions with the highest resource usage may be selected and the lines of code in the functions can be inspected to identify replacement code.

In some examples, the lines of code in the function may be compared to a dictionary that indicates replacement code to replace existing code and improve efficiency of the application. The dictionary may be generated by the developer, a web resource or database, or may be provided with the programming language. Once the replacement code is identified for the code in application 632, application summary service 630 directs processing system 650 to generate a summary for display that indicates at least the one or more lines of code identified for replacement and the replacement code for the existing code. In generating the summary, application summary service 630 may identify line numbers or provide a segment of the code to be replaced. For example, the summary may indicate that a current variable type in a line of code could be replaced with another variable type to preserve memory resources. In some implementations, in addition to identifying the code to be replaced and the replacement code, the summary may further indicate resource usage associated with each of functions with the highest resource usage. The summary may further indicate how the replacement code could improve the computing resource usage, wherein the summary may indicate a current resource usage and predicted improvements to the usage with the modifications to the code. The improvements may be associated with processing resource usage, memory resource usage, or some other usage, including combinations thereof.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
obtaining telemetry data associated with an application with a plurality of features;
determining a usage rate associated with each of the plurality of features based on the telemetry data;
identifying configuration metadata associated with the application, wherein the configuration metadata indicates at least a scale factor for scaling the usage rates of the plurality of features;
determining one or more iteration counts for testing the application based on the configuration metadata and the usage rates; and
generating a context object, wherein the context object indicates at least the one or more iteration counts for testing the application.

2. The method of claim 1, wherein the context object further indicates configuration information associated with the computing environment.

3. The method of claim 2, wherein the configuration information comprises hardware information for one or more computers to host the application, a type of container or virtual machine for the application, and a run length associated with the application.

4. The method of claim 1 further comprising:
initiating a test of the application using the context object to determine computing resource usage associated with a plurality of functions in the plurality of features;
identifying a subset of functions from the plurality of functions with a highest computing resource usage from the test;
identifying one or more lines of code in the subset of functions associated with the highest computing resource usage;
determining replacement code for the one or more lines of code to improve the computing resource usage; and
generating a summary for display that indicates at least the one or more lines of code in the subset of functions and the replacement code.

5. The method of claim 4, wherein the summary further indicates the subset of functions.

6. The method of claim 5, wherein the summary indicates the resource usage associated with each of the functions.

7. The method of claim 4, wherein the computing resource usage comprises processing resource usage or memory resource usage.

8. The method of claim 1, wherein the application comprises a Go language application.

9. A computing apparatus comprising:
a storage system;
a processing system operatively coupled to the storage system;
program instructions stored on the storage system that, when executed by the processing system, direct the computing apparatus to:
obtain telemetry data associated with an application with a plurality of features;
determine a usage rate associated with each of the plurality of features based on the telemetry data;
identify configuration metadata associated with the application, wherein the configuration metadata indicates at least a scale factor for scaling the usage rates of the plurality of features;
determine one or more iteration counts for testing the application based on the configuration metadata and the usage rates; and
generate a context object, wherein the context object indicates at least the one or more iteration counts for testing the application

10. The computing apparatus of claim 9, wherein the context object further indicates configuration information associated with the computing environment.

11. The computing apparatus of claim 10, wherein the configuration information comprises hardware information for one or more computers to host the application, a type of container or virtual machine for the application, and a run length associated with the application.

12. The computing apparatus of claim 9, wherein the program instructions further direct the computing apparatus to:
initiate a test of the application using the context object to determine computing resource usage associated with a plurality of functions in the plurality of features;
identify a subset of functions from the plurality of functions with a highest computing resource usage from the test;
identify one or more lines of code in the subset of functions associated with the highest computing resource usage;
determine replacement code for the one or more lines of code to improve the computing resource usage; and
generate a summary for display that indicates at least the one or more lines of code in the subset of functions and the replacement code.

13. The computing apparatus of claim 12, wherein the summary further indicates the subset of functions.

14. The computing apparatus of claim 13, wherein the summary indicates the resource usage associated with each of the functions.

15. The computing apparatus of claim 12, wherein the computing resource usage comprises processing resource usage or memory resource usage.

16. The computing apparatus of claim 9, wherein the application comprises a Go language application.

17. A method comprising:
initiating a test of an application using a context object to determine computing resource usage associated with a plurality of functions of the application, wherein the context object indicates at least iteration counts for features that each comprise a portion of the plurality of functions;
identifying a subset of functions from the plurality of functions with a highest computing resource usage from the test;
identifying one or more lines of code in the subset of functions associated with the highest computing resource usage;
determining replacement code for the one or more lines of code to improve the computing resource usage; and
generating a summary for display that indicates at least the one or more lines of code in the subset of functions and the replacement code.

18. The method of claim 17, wherein the summary further indicates the subset of functions.

19. The method of claim 17, wherein the computing resource usage comprises processing resource usage or memory resource usage.

20. The method of claim 17 further comprising:
obtaining telemetry data associated with the application;
determining a usage rate associated with each of the features based on the telemetry data;
identifying configuration metadata associated with the application, wherein the configuration metadata indicates at least a scale factor for scaling the usage rates of the plurality of features;
determining the iteration counts for testing the application based on the configuration metadata and the usage rates; and
generating the context object.
